(19) United States
(12) Patent Application Publication
(10) Pub. No.: US 2018/0244341 A1
(43) Pub. Date: Aug. 30, 2018

(54) WHEEL KIT WITH AN ELECTROMAGNETIC DRIVE AND WHEELED VEHICLE COMPRISING A WHEEL KIT WITH AN ELECTROMAGNETIC DRIVE AND A METHOD FOR USE OF SUCH A WHEEL KIT

(71) Applicant: Altidea Kft., Gyongyostarjan (HU)

(72) Inventor: Csaba Urban, Oroszlany (HU)

(73) Assignee: Altidea Kft., Gyongyostarjan (HU)

(21) Appl. No.: 15/756,873

(22) PCT Filed: Sep. 1, 2016
(86) PCT No.: PCT/HU2016/050041

§ 371 Date: Mar. 1, 2018

(30) Foreign Application Priority Data
Sep. 2, 2015 (HU) P1500398

(51) Int. Cl. B62M 6/45; H02K 7/14; H02K 11/00; H02K 11/21; H02K 11/35; B62M 6/40

(52) U.S. Cl. CPC B62M 6/45; H02K 7/14; B62M 6/40; H02K 11/21; H02K 11/35; H02K 11/0094

(57) ABSTRACT

The invention relates to a Wheel kit (10) with an electromagnetic drive comprising a wheel (12) having a rim (12a) and a wheel hub (12b), the wheel (12) being mountable on a frame (22) of a vehicle (20) rotatably around an axle (12t) of the wheel hub (12b), the wheel kit (10) further comprising at least one electromagnet (14) arranged along the rim (12a) of the wheel (12), and a magnetic stationary part (18) attachable to the frame (22) of the vehicle (20), characterised by comprising at least one control system (16) for controlling the power supply of the at least one electromagnet (14), and the control system (16) is adapted:
to turn on the electromagnets (14) in a magnetic field of the magnetic stationary part (18), and
to turn off the electromagnets (14) outside of the magnetic field of the magnetic stationary part (18).

The invention further relates to a wheeled vehicle (20) comprising a frame (22), and a method for use of such a wheel kit (10).

The invention relates to a wheel kit with an electromagnetic drive comprising a wheel having a rim and a wheel hub, the wheel being mountable on a frame of a vehicle rotatably around an axle of the wheel hub.

The invention further relates to a wheeled vehicle comprising a frame which contains such a wheel kit.

Most frequently it is internal combustion engines or electric motors using electric energy that are used to drive vehicles. In the future, as fossil fuels are depleted, as well as due to the intensification of efforts to protect the environment, it is expected that electric vehicles will become widespread. As a consequence of urbanisation and the increase in the population there is an exceptionally large demand for cheap motorised vehicles that can be stored in a small space and that use a small amount of energy, such as electric bicycles.

Many methods have been developed over the past decades for the electric drives of bicycles. Among these, one of the first solutions was the friction drive, during which a direct current electric motor rotates one of the wheels of the bicycle in such a way that the power transmission between the electric motor and the wheels is ensured by friction. The friction drive is a technically simple solution, however, it has numerous disadvantages, such as:
as a result of the deformations caused by the friction and the slip phenomenon, there are great mechanical losses,
greater capacity motors are required as a result of the mechanical losses,
greater slip occurs in wet weather,
increased tyre wear.

U.S. Pat. No. 4,168,758 and U.S. Pat. No. 4,541,500 discuss an electric bicycle in the case of which the transmission of power between the electric motor and the driven wheel is provided by a chain. Although a chain drive is free of the aforementioned disadvantages of the friction drive, the significant mechanical losses still present mean that this solution has not become widespread.

The currently most frequently used electric bicycle drive is the hub motor. In the case of this solution the electric motor is built into the wheel hub of the driven wheel, around the axle of rotation of the wheel. An electric bicycle driven by such a wheel hub motor is presented by, for example, U.S. Pat. No. 4,346,777. The greatest advantage of the wheel hub motor is that due to the lack of components that come into contact with each other and due to its enclosed construction, it is practically maintenance-free. However, as the wheel hub motor drives the wheel in the immediate vicinity of the wheel's axle, a great deal of torque is required to accelerate the vehicle. The great torque requirement demands a large amount of starting current, which result in the faster deterioration of the batteries and the motor control electronics. The motor's large current demand produces a large amount of heat, which cannot be easily dissipated due to the enclosed and compact structure of the wheel hub motor. Overheating of the motor causes a reduction in the performance of the motor, as the resistance of the coils of the electromagnets increases due to the effect of being heated up. The motor's overheating can lead to it becoming faulty.

All of the solutions presented above use radial flux electric motors, in the case of which the magnetic poles of the magnets built into the rotor and stator of the motor are perpendicular to the axis of rotation, located radially. As opposed to this, in the case of axial flux electric motors, the magnetic poles of the magnets built into the rotor and stator are arranged in parallel to the axis of rotation of the electric motor. With an axial arrangement motors can be constructed that are flattened in the plane perpendicular to the axis of rotation of the motor. Axial flux electric motors have numerous advantages as compared to radial flux electric motors, which are the following:
greater toque per motor-kilogram (Nm/kg),
more effective cooling due to the larger, flattened motor surface,
greater extractable specific performance as a result of the better cooling,
greater efficiency due to lower cooling losses.

U.S. Pat. No. 5,788,007 and U.S. Pat. No. 7,191,861 present an axial flux electric motor built into a bicycle in the case of which the one or more electromagnets operating the motor are fixed to the frame of the bicycle, while the permanent magnets creating the permanent magnetic field are built into the wheel rim. A battery provides the power supply required for the one or more electromagnets, and separate electronics take care of their control. The torque of the motor established in this way is suitably large, and has a good level of cooling efficiency. The greatest disadvantage of this arrangement is that the permanent magnets built into the wheel rim get close to the road surface as the wheel rotates, from where they can attract magnetisable materials (such as steel waste, screws, nails, etc.) to themselves, and the foreign items attached to the magnets may cause damage to the motor.

The solution presented in U.S. Pat. No. 6,806,608 differs from the descriptions in U.S. Pat. No. 5,788,007 and U.S. Pat. No. 7,191,861 in that instead of permanent magnets, ferromagnetic steel elements are built in the wheel rim, which are attracted by the electromagnets fixed to the vehicle's fame. When a steel element gets into the position that is the closest to the given electromagnet, the electromagnet is switched off and the attractive force disappears, and then the steel element continues to move due to the inertia of the wheel. Here also separate electronics are used to control the electromagnets, and the position of the wheel is monitored by sensors, such as infrared diodes. By using steel elements instead of permanent magnets the problem presented above disappears, but as the electromagnets exert less attraction on the steel elements than on the permanent magnets, the motor's torque is lower.

Patent document number GB 2469755 presents a wheel which has electromagnets built into the surface of its rim in the plane of the wheel, which are supplied with current through metal bearings. The stator is an electromagnet located above the wheel. The purpose of the device is to drive and brake the wheel. The teaching of the document is considerably lacking, as it states nothing about the control of the electromagnets. As all the specification discloses is that the electromagnets obtain the current required for their operation through the wheel bearings, this solution is to be viewed as a single-phase motor. In this solution there is no mention at all of the electromagnets built into the wheel being controlled, as the control of the electromagnets of the stator is much simpler and obvious in the knowledge of the state of the art. The greatest disadvantage of the solution is that as during operation all of the electromagnets of the wheel are switched on, while the wheel is rotating the electromagnets getting close to the road surface may attract magnetisable material (such as steel waste, screws, nails, etc.) to themselves, which may cause damage to the motor. The other great disadvantage of the solution is that the electromagnets at a distance from the magnetic stator consume electricity in such a way that they do not contribute to increasing the motor's torque. The unnecessarily operated electromagnets greatly impair the efficiency of the motor and reduce the motor's ability to dissipate heat.

Patent application number WO 2007/010300 presents a four-wheel-drive electric vehicle that contains at least two electric motors, energy sources and control units. Of the device's motors, at least one is a starting motor and at least another is a drive motor. The device contains an even number of magnets and an even number of diametrically opposed electromagnets that are separated by an air gap. In this case the motor's electromagnets are not arranged in the wheel rim and so the disadvantages presented above in connection with wheel hub motors appear here also.

Document number US 2015/0061440 presents an electric motor that contains the permanent and electromagnets in a Halbach array. According to the structure they may be arranged in line and circularly.

U.S. Pat. No. 6,470,933 presents a vehicle tyre construction where there are sensors built into the tyre, which sensors are supplied with electricity induced in coils built into the tyre by the external magnetic field of a stator. The system also contains a controller that collects and processes the signals from the sensors in order to give feedback about the condition of the tyre. According to the specification the arrangement of both the stator's magnets and the coils built in the tyre is rotationally symmetrical. The arrangement according to the solution is not suitable for driving the wheel.

U.S. Pat. No. 9,027,681 presents a wheel hub motor arrangement, which serves to provide motor-assisted cycling and to drive the bicycle. The device may include a battery, electric motor, sensors and a control unit. As the electromagnets of the motor are not in the wheel rim in this case either, the disadvantages presented above in connection with wheel hub motors appear here also.

The aim of the present invention is to provide a wheel kit with an electromagnetic drive and a wheeled vehicle that comprises a wheel kit with an electromagnetic drive that is free of the disadvantages of the solutions according to the state of the art.

It was recognised that by positioning the electromagnets along the wheel rim great motor torque may be provided as compared to the torque of traditional electric motors.

It was also recognised that the magnets built into the wheel rim and getting into close proximity to the road surface may attract magnetisable materials to themselves from the road, which may cause damage to the motor.

Furthermore, it was recognised that by appropriately regulating the electricity supply to the electromagnets, the magnetic field may be interrupted in the proximity of the road surface, and the energy use and heat dissipation of the motor can be significantly improved.

In accordance with the invention, the task was solved with the wheel kit according to claim 1.

Furthermore, the task set for the invention was solved with the wheeled vehicle according to claim 12.

Further advantageous embodiments of the invention are defined in the attached dependent claims.

Further details of the invention will be apparent from the accompanying figures and exemplary embodiments.

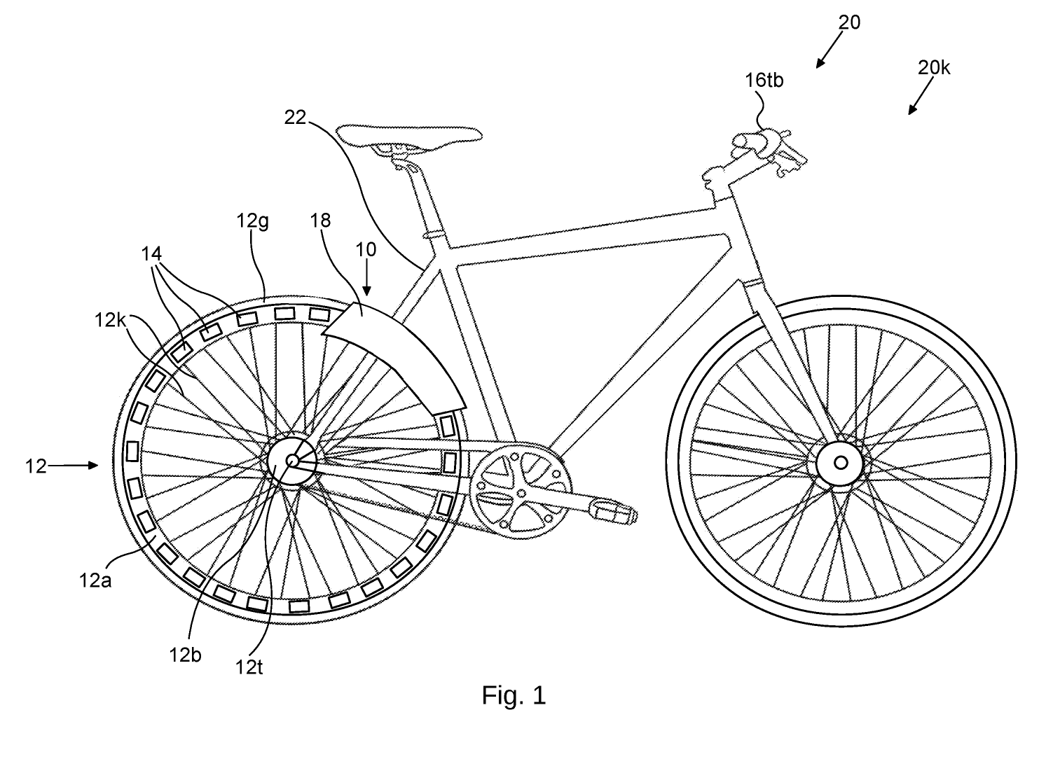

FIG. 1 is a schematic view of a preferred embodiment of a wheeled vehicle comprising a wheel kit with the electromagnetic drive according to the invention,

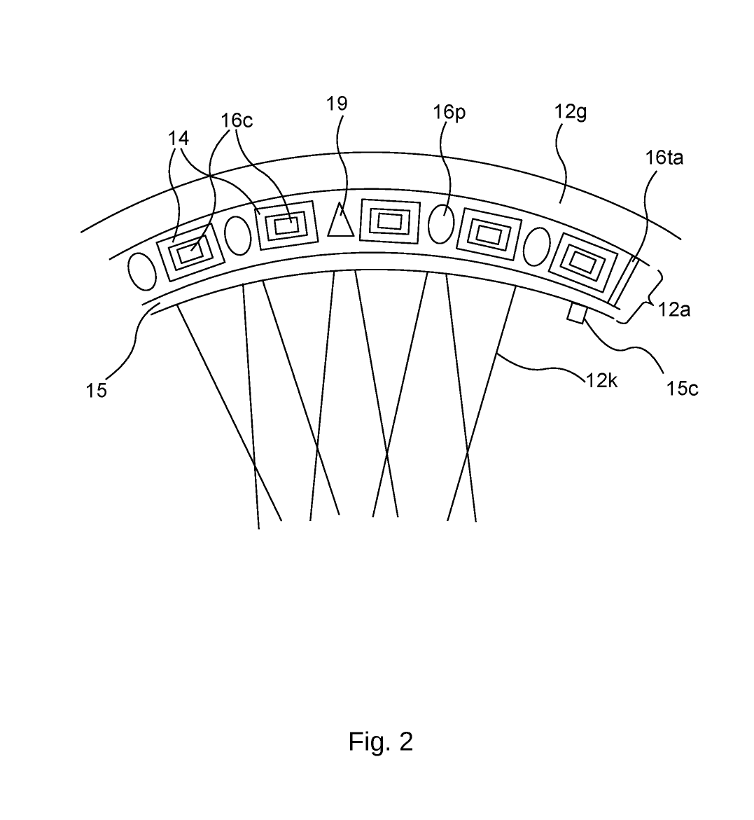

FIG. 2 is a schematic cross-sectional view illustrating a preferred embodiment of a wheel rim of the wheel kit according to the invention,

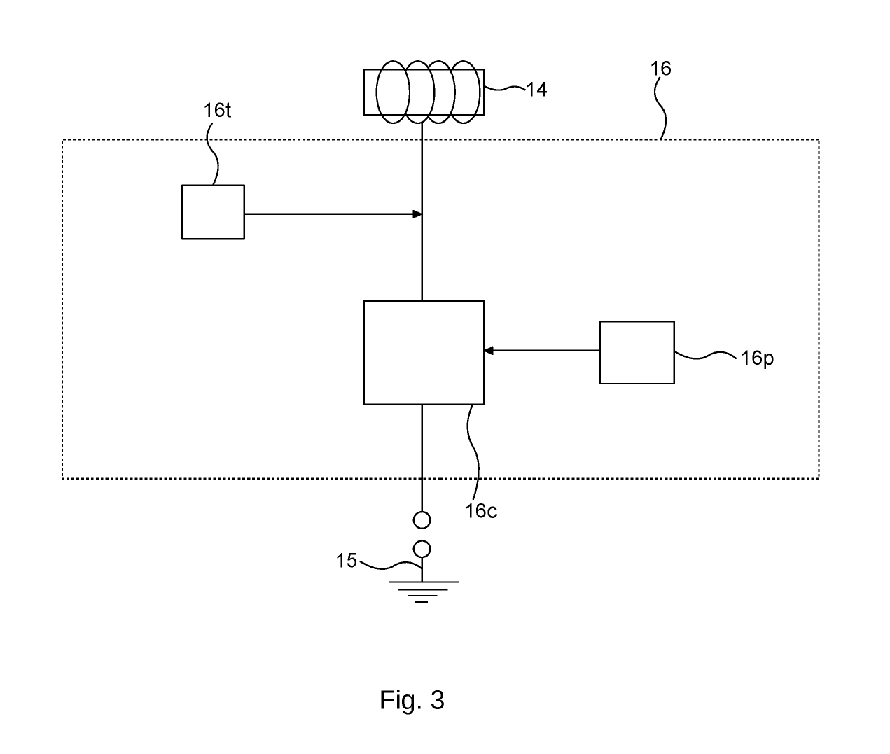

FIG. 3 shows a schematic block diagram of a preferred embodiment of the control system according to the invention,

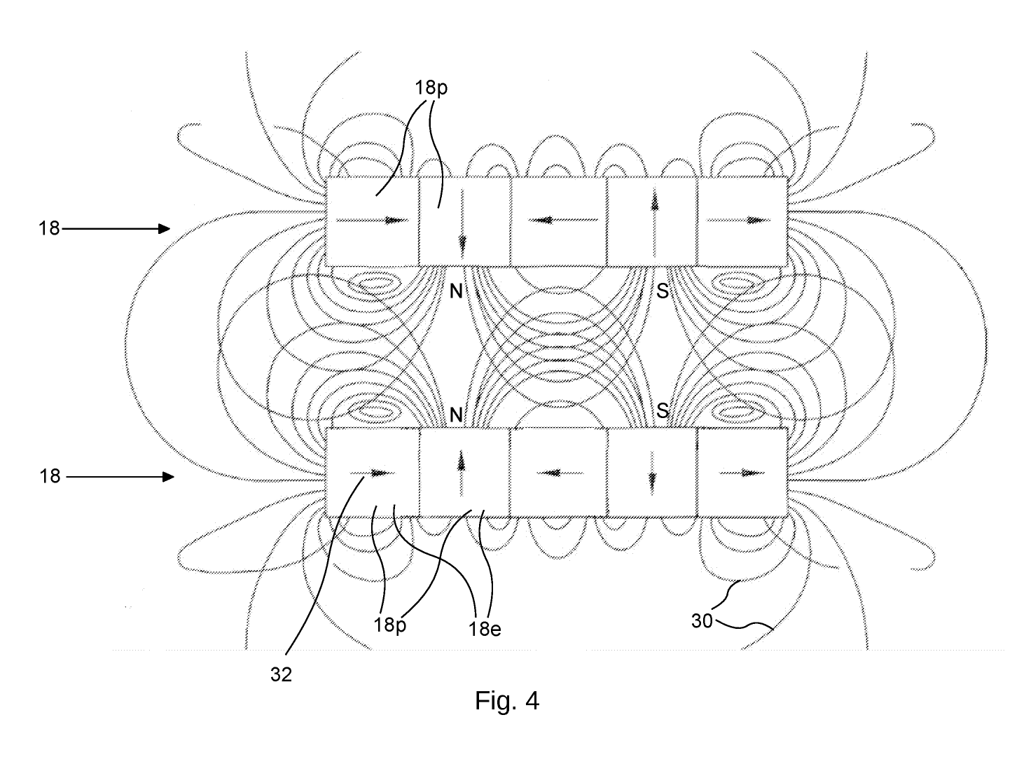

FIG. 4 is a schematic top view illustrating a preferred embodiment of the magnetic stationary part of the wheel kit according to the invention,

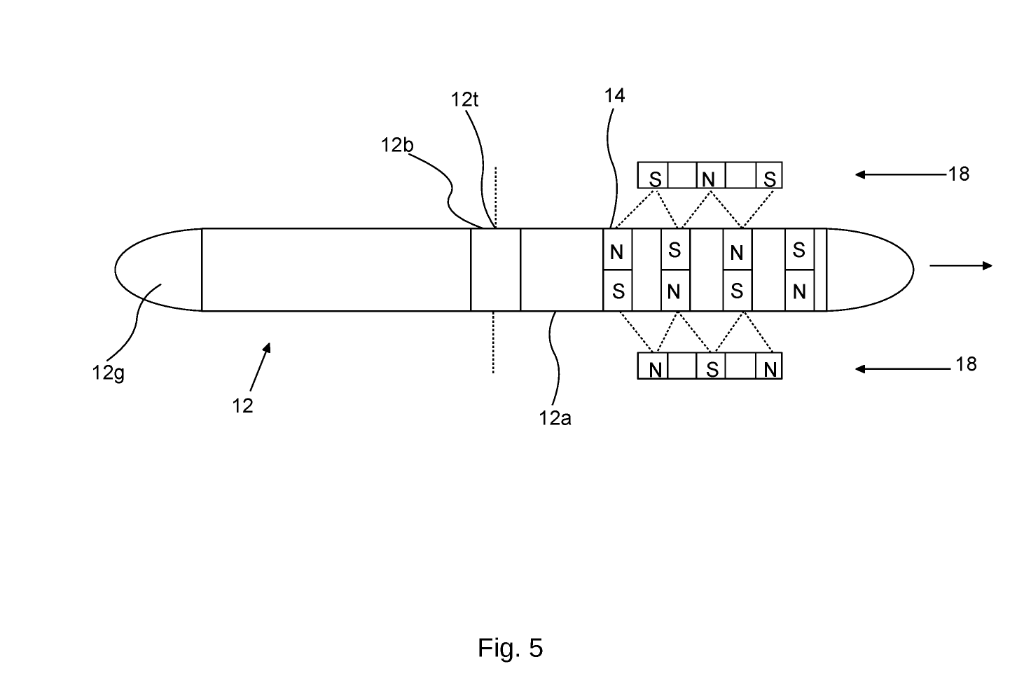

FIG. 5 is a schematic cross-sectional view of a preferred embodiment of the wheel kit according to the invention.

FIG. 1 illustrates a schematic picture of a preferred embodiment of a wheeled vehicle 20 comprising the wheel kit 10 with electromagnetic drive according to the invention. In this embodiment the vehicle 20 is a bicycle 20k. The wheel kit 10 comprises a wheel 12 with a rim 12a and a hub 12b, which wheel 12 may be mounted onto the frame 22 of the bicycle 20k so that it may rotate around the axle 12t of the wheel hub 12b. The mounting may take place with, for example, a bolt or an easily operable quick release lock, as is obvious to a person skilled in the art. The rim 12a is the U-cross-sectional part of the wheel 12, which is made from light, rigid material that cannot be magnetised, which may be, for example, aluminium, carbon fibre, plastic or other composite material. A tyre 12g fixed with a flange established on the external edges of the rim 120 is located along the external circumference of the wheel rim 12a, via which the wheel 12 comes into contact with the road surface. The wheel kit 10 comprises at least one electromagnet 14 arranged along the rim 12a of the wheel 12, a control system 16 (see FIG. 3) serving for regulating the power supply to the at least one electromagnet 14 and a magnetic stationary part 18 that may be fixed to the frame 22 of the bicycle 20k. In this embodiment the electromagnet 14 is a coil, which creates a magnetic field due to the effect of the electric current flowing through it, and which loses its magnetic property if the electric current is switched off. The magnetic force lines produced by the coil are parallel to the axis of the coil within the coil, designating the north and south poles of the magnetic field. In a given case a high permeability ferromagnetic material, such as an iron core, especially soft iron alloyed with nickel and/or cobalt may be placed inside the coil of the electromagnet, with which the magnetic capacity of the electromagnet 14 may be increased. Naturally an embodiment may be conceived in the case of which the inside of the coil of the electromagnet 14 is hollow, or is filled with a non-ferromagnetic material. In this case the mass of the coil is less than that of a coil comprising a ferromagnetic core, and also pulsating torque and cogging torque created as a result of the iron core are reduced or terminated.

In the case of the embodiment depicted in FIG. 1 the wheel 12 comprises spokes 12k connecting the wheel hub 12b to the rim 12a, the material of which may be, for example, aluminium, acid-resistant steel, composite or other material with suitable strength. The shape of the end of the spoke 12k may be hemispherical, or lens headed, and this structure is use to connect the spoke 12k to the appropriate bore in the flange of the wheel hub 12b. The wheel kit 10 also preferably includes one or more rechargeable power supplies 15 electrically connected to the at least one electromagnet 14 and to the control system 16 serving to regulate the electricity supply to the at least one electromagnet 14, which power supply 15 is preferably a lithium cell battery, even more preferably a lithium polymer battery. Naturally other types of battery are also conceivable, such as NiMH and NiCD batteries, etc. In the case of a preferred embodiment the power supply 15 is set up in such a way that it may be easily removed from the wheel kit 10 and then easily replaced.

In the case of an especially preferred embodiment, the power supply 15 and several electromagnets 14 are arranged within the U-cross-sectional wheel rim 12a, all round its entire circumference, as can be seen in FIG. 2. The power supply 15 can be preferred charged with electricity via the charging connector 15c located on the side of the wheel rim 12a. One of the advantages of integration into the rim 12a is that greater protection is provided for the components against environmental effects, such as dust and water. A further advantage of the construction is that it endows a more aesthetic, compact appearance to the bicycle 20k, and also makes retrofitting of the wheel kit 10 easier for the user, as will be presented in detail later on. Naturally an embodiment may also be conceived in the case of which the electromagnets 14 are fixed outside the rim 12a, in its proximity (for example, on the one or on both sides of the rim 12a), and/or the rechargeable power supply 15 is established outside of the rim 12a, such as in the wheel hub 12b. If the power supply 15 is established in the wheel hub 12b, then it is preferable if the electricity supply for the electromagnet 14 established along the rim 12a is ensured along at least one spoke 12k. In this case the cable transporting the current from the power supply 15 required for the operation of the electromagnet 14 may be established within the spoke 12k, running beside the spoke 12k, or from the material of the spoke 12k itself. A bicycle 20k may also be conceived in the case of which the rim 12a and the wheel hub 12b are not connected by spokes 12k, but with another supporting element, such as a supporting element established in the shape of a disc, in this case the necessary cables may run through the inside of the disc. Another possibility is, for example, that the power supply 15 is fixed to the frame 22 of the vehicle 20, in a given case inside it, in a way so that it may be easily removed. In this case the cables connecting the power supply 15 to the electromagnets 14 may also run through the wheel hub 12b to the frame 22, which may take place using a rotating contact providing a galvanic connection, or using a contact-free rotating transformer, as is known to a person skilled in the art.

The stationary part 18 that may be fixed to the frame 22 of the vehicle 20 comprises at least one permanent magnet 18p and/or electromagnet 18e. The permanent magnet 18p is preferably of a ferromagnetic material that retains its magnetic properties (external magnetic field) without being magnetised. Materials are preferable for its production that have a high coercive force, such as neodymium-iron-boron, samarium, strontium ferrite, etc.

In the case of the embodiment presented in FIG. 2 the axes of the electromagnets 14 are arranged to be perpendicular to the plane of the wheel 12, in other words the straight line linking the north and south poles of the magnetic field generated by the electromagnets 14 is perpendicular to the plane of the wheel 12. Several electromagnets 14 are arranged along the rim 12a of the wheel 12, and the control system 16 is set up in such a way so as to be able to switch on the electromagnets 14 when they are in magnetic field of the magnetic stationary part 18 and switch off the electromagnets 14 when they are outside the magnetic field of the magnetic stationary part 18.

In the case of an exemplary embodiment, the control system 16 comprises a control circuit 16c, an output control system 16t and a position sensor 16p, the schematic block diagram of which may be seen in FIG. 3.

The position sensor 16p has a wired or wireless connection with the control circuit 16c. The wireless connection may be realised with, for example, a known short range protocol using radio waves, such as Bluetooth, or ZigBee, etc. The position sensor 16p is able to determine the position of the electromagnet 14 arranged along the rim 12a as compared to the stationary part 18 fixed to the frame 22. The position sensor 16p is preferably a contactless sensor, which may be, for example, an inductive sensor, capacitive sensor, a Hall sensor, or other magnetic sensor or optical sensor, etc., as is obvious for a person skilled in the art. In a given case an embodiment may be conceived in the case of which the voltage induced in the at least one electromagnet 14 passing in the proximity of the stationary part 18 while the rim 12a is rotating is measured, and then the position of the electromagnet 14 as compared to the stationary part 18 is determined on the basis of this. In this case it is not necessary to use a separate position sensor 16p.

The embodiment illustrated in FIG. 2 comprises several position sensors 16p built into the rim 12a, all of which are connected to a control circuit 16c regulating the electricity supply of one or more electromagnets 14. In the case of a preferred embodiment the control circuit 16c comprises a unit (PWM controller) capable of producing pulse width modulated (PWM) voltage signals and one or more H-bridge or half-bridge switches (output electronics) preferably realised using field effect transistors (FET), as is known to a person skilled in the art. With the appropriate control of every H-bridge or half-bridge switch, the direction and strength of the current passing through the electromagnet 14 may be controlled and so electric current with the signal shape (amplitude, frequency and phase angle) according to the control algorithm known from the literature, for example, can be conducted though the electromagnet 14, through this the momentary magnetic polarity and magnetic strength of the electromagnet 14 may be varied to the desired value. A FET is a semiconductor device with three terminals the output current of which may be controlled with the low-power electric field created by the input voltage. In a given case BPJ or IGBT transistors or other switching elements suitable for the purpose may be used instead of FET transistors. By processing the position data generated by the position sensor 16p, the data provided by other possible sensors and the signal from the output control system 16t functioning as the user interface, the control circuit 16c creates pulse width modulated voltage signals in accordance with the control algorithm, with which it drives the H-bridge or half-bridge switch or switches. During the pulse width modulation a substantially rectangular signal with a constant period is created, in the case of which the regulation takes place by varying the signal's duty cycle, as is known to a person skilled in the art. Naturally the control algorithm can perform the control of the H-bridge or half-bridge switching even without precise position and speed data, for example by measuring the voltage and the current induced in the electromagnets 14 by the magnetic field of the stationary part 18. Furthermore apart from PWM control, the control of the H-bridge or half-bridge may take place in another way, such as on the basis of predefined switching patterns.

Naturally the control circuit 16c may also include other sub-circuits required for its operation, such as supply voltage conditioning, FET-driving, communication interface sub-circuits, as is obvious for a person skilled in the art.

In a given case various parts of the control circuit 16c may be located on a physically separate circuit chip. In the case of a preferred embodiment the processing of certain input parameters of the control algorithm and the determination of the control algorithm may also take place using a central controller established on a separate chip, while the control of the H-bridges may take place with separate controllers connected to the central controller in the way determined by the central controller.

In a given case the control circuit 16c, or a part of it, such as its output electronics part, may be located inside the rim 12a near to the electromagnet 14, or even in the core of the coil of the electromagnet 14, as it can be seen in FIG. 2. Naturally the control circuit 16c may be arranged elsewhere, in the wheel hub 12b or on the frame, for example. An embodiment may be conceived in the case of which one control circuit 16c controls several electromagnets 14, or in a given case all the electromagnets 14 may be controlled by a single control system 16, which instead of separate control circuits 16c comprises a single microcontroller. If necessary, in such a case, several position sensors 16p may be arranged along the rim 12a in the interest of more precise positioning.

The control system 16 preferably comprises an output control system 16t which is in wired connection with the power supply 15 and the control circuit and which is suitable for regulating the magnitude of the current and/or voltage passing from the power supply 15 to the control circuit 16c. The output control system 16t may be, for example, a potentiometer that makes it possible to change the amount of its resistance and so the amount of the current flowing through it.

In the case of an exemplary embodiment the output control system 16t comprises a first module 16ta (see FIG. 2) and a second module 16tb (see FIG. 1) that are capable of wireless communication with each other. This wireless communication may take place, for example, according to one of the short range radio frequency protocols already presented above. The first module 16ta may be, for example, a potentiometer that may be controlled in a wireless way. The second module 16tb is preferably fixed to the frame 22 of the wheeled vehicle 20, which is controlled by the operator of the vehicle 20. The module 16tb may be, for example, an accelerator lever or accelerator pedal that may be adjusted to several stages, or other control console that emits a radio signal complying with the set stage. The emitted radio signal is received by the first module 16ta, and adjusts the electric resistance value in accordance with the signal received, due to this the control circuit 16c regulates the value of the maximum current that may flow through the electromagnets 14. Instead of regulating resistance, naturally the output control system 16t may also regulate the control circuit 16c by producing and forwarding an appropriate digital signal. Naturally, output control may also be carried out in other ways, such as by using the torque sensing principle used in the known pedelec-type bicycles.

The wheel kit 10 according to the invention has one or more sensors selected from the following group that measure the physical and/or chemical characteristics of the wheeled vehicle 20 and/or its environment: speed sensor monitoring the speed of rotation of the wheel, speed sensor measuring the speed of the bicycle, acceleration sensor, a torque sensor serving to monitor the torque exerted by pedalling, ambient temperature sensor, internal temperature sensors measuring the temperature of individual components, humidity sensor, gas analysis sensor, flow sensor measuring the speed of the airflow around the vehicle 20, and gradient sensor measuring the inclination of the road surface. The one or more sensors may be positioned, for example, inside the rim 12a, in its proximity, along the axle 12t of the wheel 12, in the stationary part 18, and/or fixed to the frame 22. In a given case the data originating from the sensors may also be used as input parameters for the control system 16. In the case of an exemplary embodiment the wheel kit 10 preferably comprises a communication module 19 capable of short range radio communication, with which the data of the one or more sensors may be processed and wirelessly transmitted to the user's mobile device, which may be, for example, a smartphone, tablet, smart watch, PDA, etc. The wireless data communication may be in accordance with the Bluetooth standard, but, naturally, other communication standards are also conceivable. The sensor data processed by the communication module 19 may also be forwarded via cable to the user's mobile device, as is known to a person skilled in the art.

In the case of the embodiment presented in FIG. 1 the stationary part 18 is fixed to the bicycle's 20k rear fork, which fixing may be performed by welding, soldering or bolting, for example, as is obvious for a person skilled in the art. In the case of a preferred embodiment the stationary part 18 that may be fixed to the frame 22 of the wheeled vehicle 20 is arranged in the proximity of the rim 12a of the wheel 12 on one side of the wheel 12, or on both sides of the wheel 12, parallel to the plane of the wheel 12 in such a way that the at least one magnet of the stationary part 18 and the at least one electromagnet 14 arranged along the rim 12a get as close as possible to one another while the wheel 12 is rotating without preventing the free rotation of the wheel 12. An embodiment may also be conceived in the case of which the wheel 12 may be dismounted from and then mounted onto the vehicle 20 without removing the stationary part 18. In this case the stationary part 18 may be fixed to the frame 22 of the vehicle 20 using a bolt mechanism that ensures the possibility of rotation. In a given case an embodiment may be conceived in which the stationary part 18 is fixed to the frame 22 of the vehicle 20 with a manually adjustable or automatic mechanism that makes it possible to slightly move the stationary part 18 in directions perpendicular to the plane of rotation of the wheel 12. In this case even in spite of deformations resulting in a change to the plane of rotation of the wheel 12 due to possible forces exerted on the wheel 12 in the lateral direction a constant distance between the stationary part 18 and the wheel 12 may be ensured.

In the case of an especially preferred embodiment the stationary part 18 that may be fixed to the frame 22 of the vehicle 20 comprises several permanent magnets set up according to the Halbach array, preferably neodymium magnets. Naturally, an embodiment may be conceived in which the stationary part comprises one or more electromagnets 18e. A preferred embodiment of the stationary part 18 according to the invention may be seen in FIG. 4, in which the magnets of the stationary part 18 are arranged in a Halbach array. The points of the arrows 32 indicate the direction of the north poles of the magnets. When setting up the Halbach array several magnets were placed next to each other in the way indicated in FIG. 4. As a result of this an intensified magnetic field is created on the one side of the Halbach array, while on the other side the strength of the magnetic field is significantly weakened. On the side where the magnetic field is strengthened the north N and south S poles of the magnetic field follow each other alternately (see FIG. 4). The strength and distribution of the magnetic field may be illustrated with magnetic force lines 30 (curves) in such a way that the density of the magnetic force lines 30 is directly proportionate to the magnitude of the magnetic field, and in the individual points of the lines, the straight line determined by the magnetic field strength vector at that position is the tangent of the curve at that point. In the case of an especially preferred embodiment the magnets of the stationary part 18 in a Halbach array are arranged so that the intensified magnetic field faces towards the rim 12a of the wheel 12. In such a case the magnetic field strength is practically negligible on the outer side of the stationary part 18, due to which the stationary part 18 can be prevented from attracting magnetisable objects from outside.

In the following the operation of the wheel kit 10 according to the invention and of the vehicle 20 comprising the wheel kit 10 is presented.

The wheel kit 10 serves for powering or assisting the powering of the wheeled vehicle 20. In the case of a preferred embodiment, the wheel kit 10 is fitted onto a traditional, pedal-driven, non-motorised bicycle. In the first step of fitting the wheel kit 10 the rear wheel of the traditional bicycle is removed, and the wheel 12 of the wheel kit 10 according to the invention is fitted in its place. The axle 12t of the wheel 12 is preferably fixed to the frame 22 of the bicycle 20k with a quick release lock, but, naturally, other fixing methods may also be conceived. The fixed wheel 12 may rotate freely around the axle 12t.

In the second step the stationary part 18 of the wheel kit 10 is fixed to the frame 22 of the bicycle 20k, preferably to the rear fork using bolts and straps. In the case of an especially preferred embodiment the wheel kit 10 may be obtained in the form of various versions, which are constructed in accordance with different bicycle sizes and/or types, in this way the user can purchase a wheel kit 10 that complies with his own bicycle. In the final step the second module 16tb is fitted to the frame 22 of the bicycle 20k, preferably to the bicycle's 20k handlebars, with which the user is able to regulate the output of the electromagnets 14 of the wheel kit 10. Naturally, an embodiment may be conceived in which the wheeled vehicle 20 already comprises the wheel kit 10, so the user does not have to obtain it separately.

The essence of the wheel kit 10 according to the invention is that magnetic energy is transformed into rotational energy. In the case of a preferred embodiment the electromagnets 14 are arranged along the rim 12a of the wheel 12 so that the electromagnets 14 are positioned in the rim 12a of the wheel 12, along its entire circumference at a given distance from each other and so that the axes of the coils of the electromagnets 14 are perpendicular to the plane of the wheel 12.

If the magnets of the stationary part 18 have nearly the same strength and are located at equal distances from each other, then a spatially periodic magnetic field is created among them. As it is known to a person skilled in the art, depending on the geometry of the positioning, the pattern of the magnetic field may be sinusoidal or trapezoidal. If a number “N” of individual coils of electromagnets 14 are positioned in a space part covered by a complete magnetic period, a similar voltage pattern is induced in the individual moving coils with a phase shift of 2Pi/N. Due to periodicity the voltage induced in coil N+1 is the same as the voltage in the first coil, the voltage of coil N+2 is the same as that of the second coil, and so on. N is the number of phases. In the case of traditional electric motors, e.g. in the case N=3, the first, the fourth, the seventh, etc. (i.e. every third) coil is usually connected in series, these constitute the so-called first phase. Similarly, the second, fifth, eighth, etc. coils constitute the second phase and the third, sixth, ninth, etc. coils the third phase. In this case traditional electric motors use a three-phase motor controller.

In the case of the present invention the problem to be solved means that if the electromagnets 14 arranged at a specified distance from each other are connected to the same phase, the current will also flow through those electromagnets 14 through which the magnetic field of the stationary part 18 has not passed in such a way that they do not perform useful work in the meantime, which represents a great degree of efficiency impairment. The other problem is that the electromagnets 14 close to the road surface will also create a magnetic field, and so may collect magnetisable materials, which may lead to faults occurring.

In the case of a preferred embodiment the spatial positioning of the electromagnets is such that they form a 3-phase system. In this case the control circuit 16c comprises an adapted 3-phase motor controller and switching elements that may be separately controlled per electromagnet 14, so that by using the controllable switching elements the electromagnets 14 belonging to the given phase can be switched in and out of the circuit of the phase. The controllable switching elements are solid-state relays suitable for switching alternating current, Reed relays or other switches suitable for this purpose. Naturally the operating principle may also be applied even in the case of a different number of phases.

While the wheel 12 is rotating the control system switches off the electromagnets 14 that have passed by the stationary part 18 and only switches them on again when they approach the stationary part 18 once again. As the electromagnets 14 of the wheel 12 positioned close to the road surface are switched off, they are unable to attract magnetisable objects to themselves from the road surface, and they do not consume electric energy either. Due to the electromagnets 14 distant from the stationary part 18 being switched off the energy use and heat dissipation ability of the electric drive according to the invention are significantly improved, as compared to the solutions according to the state of the art.

In the case of a preferred embodiment the controlling of the electromagnets 14 takes place in the following way:

Using the position sensors 16p located in the wheel 12 the positions of the rim's 12a electromagnets 14 are determined as compared to the magnets of the stationary part 18. If an electromagnet 14 is in the magnetic field of the stationary part 18, electricity is conducted into the appropriate electromagnet 14 using the control circuits 16c, and the polarity is set by changing the direction of the current passing through it according to the following. With the wheel 12 rotating as the vehicle 20 progresses the polarity of the electromagnet 14 arriving at the stationary part 18 is set so that its N north pole is on the side facing the closest S south pole magnet of the stationary part 18, and/or its S south pole is on the side facing the closest N north pole magnet of the stationary part 18 (see FIG. 5). Due to this the S south pole of the magnet of the stationary part 18 will attract the N north pole of the electromagnet 14, similarly the N north pole of the magnet of the stationary part 18 will attract the S south pole of the electromagnet 14. Due to the effect of the attraction the wheel will rotate, and the electromagnet 14 gets even closer to the S south and N north pole magnets of the stationary part. In the case of the embodiment depicted in FIG. 5 a stationary part 18 is placed on each of the two sides of the rim 12a in such a way that the magnets on the opposite side of the rim 12a are positioned opposite one another and so that their polarities are opposite. When the electromagnet 14 has reached its closest approach to the stationary parts' 18 opposite polarity magnets positioned facing one another, the polarity of the electromagnet 14 is swapped using the control circuit 16c. By changing the direction of the current flowing through the coil the attractive force between the electromagnet 14 and the magnets of the stationary parts 18 turns into repulsive force, which gives further impetus to the wheel 12.

If the electromagnet 14 is not in the magnetic field of the stationary part 18, the control circuit 16c switches the electromagnet 14 out of the circuit, so no current will flow through it, and so it does not create a magnetic field around itself either.

The changing of the polarity of the electromagnets 14, as well as their switching on and off are performed by the control circuits 16c in the knowledge of the momentary position of the wheel on the basis of the data from the position sensors 16p. With the wheel 12 in a given position the position sensor 16p sends a signal to the control circuit 16c connected to it and performing the control and switching function, which as a consequence of this switches from open to closed position and conducts electricity in the direction according to the required polarity into the electromagnet 14. In a given case, an embodiment may also be conceived in the case of which the position sensor 16p is a part of the control circuit 16c.

In the case of an especially preferred embodiment the control system 16 comprises several control circuits 16c suitable for regulating the strength and direction of the current flowing through the electromagnets 14 in such a way that preferably one or, in a given case, more control circuits 16c are electrically connected to each electromagnet 14.

Such an embodiment may be realised in such a way, for example, by the coil of each electromagnet 14 being driven by a separate H-bridge or possibly half-bridge. In this case each and every electromagnet 14 may be controlled independently of the other electromagnets 14, and in practice the number of phases equals the number of electromagnets 14. The switches of the bridges may be, for example, FET transistors, BPJ or IGBT transistors, or other switching element known to a person skilled in the art. By controlling the appropriate switches of the H-bridge fed with direct current, alternating current can be conducted through the given coil. The control circuit 16c comprising the H-bridge ensures that the current flowing through the coil of the electromagnet 14 is in synchrony with the voltage generated by the magnetic field of the stationary part 18 in the coil, and that the current strength complies with the desired torque. The control circuit 16c determines the position of the coil as compared to the stationary part 18 and its speed using the position sensors 16p or, in a given case, by measuring the voltage induced in the individual coils, then controls the H-bridge with, for example pulse width modulation (PWM). Naturally the H-bridge may be controlled even without the concrete position and speed data, for example, on the analogy of the control strategies known from motor control theory (field oriented control/direct torque control, or possibly scalar control), as is known to a person skilled in the art. Naturally, the solution described is also suitable for not conducting current at all through the electromagnet 14 if the electromagnet 14 is outside of the magnetic field of the stationary part 18 by appropriately controlling the H-bridge that controls it. In a given case instead of an H-bridge or H-bridges, a half-bridge or half-bridges may be used in the solution presented.

The maximum current flowing through the electromagnet 14, and so the maximum speed of rotation of the wheel 12 may be regulated using the second module 16tb.

In the case of a preferred embodiment the position sensor 16p only sends a signal when it has passed in front of a specific part of the frame 22 (such as the stationary part 18, or the rear fork of the bicycle 20k, etc.), or has approached it sufficiently. In a given case a passive or active signal generator may be mounted on the frame 22, which the position sensor 16p detects, or the sensors 16p may also detect the frame 22 itself.

When the vehicle 20 brakes, the electromagnets 14 are switched off. Electricity is generated in the coil of the switched-off electromagnet 14 passing the stationary part 18 due to magnetic induction, which exerts a braking effect on the wheel 12. In an especially preferred embodiment the control system 16 is set up to be suitable for electrically charging the power supply 15 in such a way that the control system 16 conducts the current induced in the at least one electromagnet 14 when the vehicle 20 brakes into the power supply 15. By feeding back the braking energy, the range of the bicycle 20k may be increased.

Various modifications to the embodiments disclosed above will be apparent to a person skilled in the art without departing from the scope of protection determined by the attached claims.

1: Wheel kit (10) with an electromagnetic drive comprising a wheel (12) having a rim (12a) and a wheel hub (12b), the wheel (12) being mountable on a frame (22) of a vehicle (20) rotatably around an axle (12t) of the wheel hub (12b), the wheel kit (10) further comprising at least one electromagnet (14) arranged along the rim (12a) of the wheel (12), a power supply (15) for the electromagnet and a magnetic stationary part (18) attachable to the frame (22) of the vehicle (20), characterised by comprising at least one control system (16) for controlling the power supply of the at least one electromagnet (14), and the control system (16) is adapted:
to turn on the electromagnet (14) in a magnetic field of the magnetic stationary part (18), and
to turn off the electromagnet (14) outside of the magnetic field of the magnetic stationary part (18).

2: Wheel kit according to claim 1, characterised by that the control system (16) comprises a plurality of control circuits (16c) adapted for controlling the magnitude and direction of a current flowing through the electromagnets (14), each electromagnet (14) being electrically connected with at least one control circuit (16c) adapted to control current supplied to a given electromagnet (14) independently from the other electromagnets (14) of the wheel kit (10).

3: Wheel kit according to claim 1, characterised by comprising a rechargeable power supply (15) electrically connected with the at least one electromagnet (14) and the control system (16) provided for controlling current supplied to the at least one electromagnet (14).

4: Wheel kit according to claim 3, characterised by that the rechargeable power supply (15) is preferably a lithium cell battery.

5: Wheel kit according to claim 1, characterised by that the stationary part (18), which is attachable to the frame (22) of the vehicle (20), comprises at least one permanent magnet (18p) and/or electromagnet (18e).

6: Wheel kit according to claim 1, characterised by that the stationary part (18), which is attachable to the frame (22) of the vehicle (20), comprises a plurality of permanent magnets (18p) and/or electromagnets (18e) arranged in a Hallbach array.

7: Wheel kit according to claim 3, characterised by that the rechargeable power supply (15) is arranged inside the rim (12a) of the wheel (12).

8: Wheel kit according to claim 1, characterised by that the wheel (12) comprises spokes (12k) connecting the axle (12t) of the wheel (12) with the rim (12a) and current supply to the at least one electromagnet (14) arranged along the rim (12a) is provided along at least one spoke (12k).

9: Wheel kit according to claim 3, characterised by that the power supply (15) is arranged in the wheel hub (12b).

10: Wheel kit according to claim 3, characterised by that the power supply (15) is attached to the frame (22) of the vehicle (20).

11: Wheel kit according to claim 1, characterised by comprising at least one position sensor (16p) being operably connected to the control system (16) and being adapted to detect the position of the at least one electromagnet (14) arranged along the rim (12a) of the wheel (12) with respect to the stationary part (18).

12: Wheel kit according to claim 1, characterised by comprising at least one sensor for measuring a physical and/or chemical property of the wheeled vehicle (20) and/or its environment and being chosen from the group consisting of: speed sensor, rotation speed sensor, accelerometer, torquemeter, thermometer, humidity sensor, gas analysing sensor, flowmeter, gradient meter; the wheel kit (10) further comprising a communication module (19) of short range radio communication being connected with the at least one sensor and being adapted to process a sensor signal.

13: Wheeled vehicle (20) comprising a frame (22), characterised by comprising a wheel kit (10) with an electromagnetic drive according to claim 1.

14: Wheeled vehicle according to claim 13, characterised by being a bicycle (20k).

15: Wheeled vehicle according to claim 13, characterised by that the control system (16) is adapted to charge the power supply (15) with the current induced in the at least one electromagnet (14) during deceleration of the vehicle (20).

16: Wheeled vehicle according to claim 13, characterised by that the stationary part (18) is attached to the frame (22) in the vicinity of the rim (12a) of the wheel (12).

17: Method for use of a wheel kit (10) according to claim 1, the wheel kit (10) comprising a wheel (12) having a rim (12a) and a wheel hub (12b), and the method comprising the steps of:
mounting the wheel (12) on a frame (22) of a vehicle (20) rotatably around an axle (12t) of the wheel hub (12b),
arranging at least one electromagnet (14) along the rim (12a) of the wheel (12),
attaching a magnetic stationary part (18) to the frame (22) of the vehicle (20), and
providing a control system (16) for controlling the power supply of the at least one electromagnet (14),
characterised by:
activating, with the help of the control system (16), the at least one electromagnet (14) in a magnetic field of the magnetic stationary part (18),
turning off, with the help of the control system (16), the at least one electromagnet (14) exiting the magnetic field of the magnetic stationary part (18), which is therefore no longer interacting with the magnetic field of the magnetic stationary part (18).

18: Method according to claim 17, characterised by arranging a plurality of electromagnets (14) along the rim (12a) of the wheel (12), providing a plurality of control circuits (16c) in the control system (16) in such a way that at least one control circuit (16c) is connected to each of the electromagnets (14) arranged along the rim (12a) of the wheel (12), and controlling each electromagnet (14) independently from the other electromagnets (14) with help of the control circuit connected with the given electromagnet (14).

19: Method according to claim 17, characterised by controlling the magnitude and direction of a current flowing through the at least one electromagnet (14), during the activation of the at least one electromagnet (14) in the magnetic field of the magnetic stationary part (18).

20: Method according to claim 17, characterised by that the stationary part (18) comprises at least one permanent magnet (18p) and/or at least one electromagnet (18e), and the magnetic field of the stationary part (18) is generated by the at least one permanent magnet (18p) and/or the at least one electromagnet (18e).

21: Method according to claim 17, characterised by providing at least one position sensor (16p) being in wired or wireless connection with the control system (16) and being adapted to detect the position of at least one electromagnet (14) arranged along the rim (12a) of the wheel (12) with respect to the stationary part (18), and using the position sensor (16p) to determine the position of the electromagnet (14) arranged along the rim (12a) of the wheel (12).
